(19) United States
(12) Patent Application Publication
(10) Pub. No.: US 2009/0327245 A1
(43) Pub. Date: Dec. 31, 2009

(54) Database systems and methods for providing customizable themes for presentations

(76) Inventors: Chon Meng Wong, Lincoln, RI (US); An-Kwok Ian Wong, Lincoln, RI (US)

Correspondence Address: STEPTOE & JOHNSON LLP, 1330 CONNECTICUT AVENUE, N.W., WASHINGTON, DC, 20036, US

(21) Appl. No.: 12/457,541

(22) Filed: Jun. 15, 2009

Related U.S. Application Data
(60) Provisional application No. 61/129,278, filed on Jun. 16, 2008.

(51) Int. Cl. G06F 15/16; G06F 17/30

(52) U.S. Cl. 707/3; 709/238; 707/E17.108; 709/227

(57) ABSTRACT

A method of and system for providing a theme based presentation is provide, preferably including detecting the presence of a mobile node within a range of a router node, querying a relational database with a unique ID of the mobile node for a group identifier corresponding to the theme based presentation, and triggering at least one activity based on the group identifier. This invention allows customized presentation of an application device response to the being wearing the mobile node within its range of approach, identifying its profile.

### CROSS REFERENCE TO RELATED APPLICATIONS

The present application claims priority to U.S. Provisional Application 61/129,278, filed on Jun. 16, 2008, the disclosure of which is expressly incorporated by reference herein in its entirety.

### BACKGROUND OF THE INVENTION

1. Field of the Invention

The present invention relates generally to systems and methods for providing customized/customizable theme based presentations. More particularly, embodiments of this invention relate to providing a relational database that allows for multiple customized/customizable theme based public or private presentations.

2. Discussion of Background Information

It is generally understood that individuals and/or groups of individuals may visit facilities of interest for any number of reasons, such as for business or pleasure. In one example, the Smithsonian Institution in Washington, D.C. offers visitors a unique opportunity to explore museums and exhibits on areas of interest including art, history, science and technology, amongst others. Some public facilities, including some of the Smithsonian museums noted above, provide guided tours, guide maps, and/or guide books to enhance the visitor experience. Even with these enhancements, however, visitors are not provided with a sufficiently tailored or guided presentation of the exhibits and associated information the museums have to offer to maximize the visitors' experience.

### SUMMARY

Embodiments of the present invention are directed at improving upon one or more of the aforementioned deficiencies. At least one embodiment of the present invention is directed at providing visitors and/or groups of visitors with tailored and/or guided presentations (e.g., of objects and events) based on dynamic information. These tailored and/or guided presentations can occur in a public place or a private place. Examples of dynamic information include interests, age, gender, and language abilities of visitors. Examples of private and public places include museums, shopping malls, cities, university campuses, government buildings, parks, etc.

Preferably, by providing a tailored and/or guided presentation, visitors can participate in a more custom, meaningful way than when using existing systems and methods. By way of example, embodiments of the present invention preferably eliminate or reduce limitations associated with fixed floor layouts, tour routes, presentations, and/or language issues. Groups of visitors, such as a tour group with similar interests, can thus benefit from tailoring and/or guided presentations based on different sub interests, languages, genders and/or age groups.

According to an embodiment of the invention, a theme based presentation system is provided. A processor has access to a relational database, the relational database including a plurality of group identifiers corresponding to theme based activities. A plurality of router are each adapted and configured to run at least one theme based activity. At least one mobile node, each mobile node having a unique ID, is provided. The plurality of router nodes are triggered to run the at least one theme based activity based on a group identifier from the plurality of group identifiers corresponding to the unique ID of the at least one mobile node.

The above embodiment may have various optional features. The processor may be a microcontroller, a CPU, or a server with multiple CPUs. The unique ID may comprises a globally unique ID or a locally unique ID. The at least one mobile node may includes a transceiver adapted and configured to transmit the unique ID to at least one router node. A local network may include a group of router nodes corresponding to an exhibit. The at least one mobile node may include a transceiver adapted and configured to join the local network when within a known distance of at least one of the router nodes in the group of router nodes. Each router node may include at least one of lighting, a video display, an audio display, or a direction sign. The at least one mobile node may be one of an MP3 player, a cellular phone, and a tag module.

According to another embodiment of the invention, a method of providing a theme based presentation is provided. The method includes: detecting the presence of a mobile node within a range of a router node; querying a relational database with a unique ID of the mobile node for a group identifier corresponding to the theme based presentation; and triggering at least one activity based on the group identifier.

The above embodiment may have various optional features. The group identifier may exclude certain activities based on a user profile corresponding to the unique ID. The method may include populating the relational database, such as by receiving ranking information from the mobile node. Querying a relational database may include transmitting data over at least one of a wireless and a wired network. The method may include activating the mobile node prior to detecting the presence of the mobile node within the range of the router node. The method may include joining a local network including the router node after detecting the presence of the mobile node within the range of the router node. The triggering at least one activity based on the group identifier may include directing the mobile node to router nodes capable of running activities of interest for the group identifier, or running a game on the mobile node. The relational database is may distributed into local microdatabases, each microdatabase corresponding to one of a local network and a grouping of unique IDs. The step of querying a relational database with the unique ID of the mobile node for the group identifier may include providing both a first and a second group identifier corresponding to distinct theme based presentations, and the step of triggering at least one activity based on the group identifier comprises triggering a plurality of activities corresponding to the first and second group identifiers. The triggering the plurality of activities corresponding to the first and second group identifiers may include simultaneously triggering the plurality of activities corresponding to the first and second group identifiers. The method may include providing bidirectional communication between the mobile node and the relational database through nodes within a given network tree, at least one of the nodes including a broadband link to a computer maintaining the relational database. The method may include maintaining a current network tree report within the relational database.

Other benefits may also be realized using one or more of the embodiments of the present invention, as would be readily understood by those of skill in the art after reading this disclosure.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 depicts a system capable of providing a theme based presentation according to an embodiment of the present invention.

FIGS. 2 and 3 depict a method for providing a theme based presentation according to an embodiment of the present invention.

FIG. 4 depicts a flowchart of a router node functionality according to an embodiment of the present invention.

FIG. 5 depicts a flowchart of database functionality according to an embodiment of the present invention.

### DETAILED DESCRIPTION OF EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Currently, digital photo frames can store thousands of pictures and they can be displayed sequentially or in prearranged clusters. However, order and selection of photos and/or clusters to be presented at the viewing instance is not determined by sensing the current viewer's profile. A customized presentation can provide a very pleasant experience with instantaneous gratification to the viewer. Embodiments of the invention can provide a customized advertising campaign showing products relevant to the current viewer. Similar applications can be applied to the electronic billboards seen on highways and in department stores to attract customers based on their profiles.

Embodiments of the invention can also be used with a digital EBook permitting stories with different contents or different versions story endings can be presented to the reader according to their taste. Reader's satisfaction will improve significantly since the story ending would suit their taste. The organization of different stories will be retrieved according to the reader's profile.

Another application of embodiments of the invention is a login process on a computer with multiple user names. Currently, specific profiles are pre-setup in computer according to different users under different login user names or IDs. All these can be simplified if the user profile is sensed from a mobile device worn by the user. When the wearer carries the mobile device and he or she can visit any public computer having a router node, which configures the settings as dictated by the profiles, including favorite websites, word documents configurations, etc. The profile details can even be downloaded from a specific website automatically to enable these features once the user had pre-registered their profile on this website.

In an environment such as a concert with microphone settings, visual lightings, sceneries arrangement, they all can be organized as different profiles. The profiles can be triggered when the performer enters the stage or picks up the microphone. The performer wearing the mobile profile device would trigger the settings accordingly giving the customized presentation to the audience.

As illustrated in the discussion below, various embodiments of the present invention are directed at systems and methods for providing customized/customizable theme based presentations. According to at least one embodiment of the present invention, customized/customizable theme based presentations may be provided using a relational database. Other types of databases, such as object databases, XML databases, microdatabases etc., may also be used. Microdatabases have the advantage of fitting into the limited memory of the mobile devices or even the memory of the digital photo frames, digital billboards, ebooks, etc.

Preferably, the relational database can be accessed by a system operating in a discovery mode, whereby the database is manually and/or automatically populated with information relevant to customized/customizable themes the relational database will help provide. To illustrate with a system as may be used in a museum, the system could be configured to operate (in whole or in part) for a period of time (or continuously) in a discovery mode during which visitors or staff have the ability to rank exhibits in the museum. This ranking information may, in turn, be used to populate the relational database.

In one example, a keypad, keyboard, touch screen display, voice entry system, joystick, mouse or other input device at an exhibit stand can be accessed by visitors and used thereby to manually enter exhibit ranking information (and preferably dynamic information about the ranking visitor). In another example, a wired or wireless tag module may be worn or carried by visitors and may similarly include an input device whereby the visitor may manually enter exhibit ranking information (and preferably dynamic information about the ranking visitor). Preferably, the tag module interfaces with a receiver (e.g., located near an exhibit stand) with access to the relational database (e.g., over a local access network (LAN), a wide area network (WAN), etc.). In yet another example, visitors may use a cell phone, iphone, palm top device, or personal data assistant (PDA) with an input device whereby the visitor may manually enter exhibit ranking information (and preferably dynamic information about the ranking visitor). Preferably, the cell phone/iphone/palm top device/PDA transmits exhibit ranking information to a receiver (e.g., a cell tower, WiFi receiver, etc.) with access to the relational database (e.g., by text messaging or over an associated Internet connection or cellular network connection). Combinations of the aforementioned techniques are also plausible. Using one or more of the aforementioned techniques or other techniques, a system including the relational database can be kept sufficiently up to date without overloading concerns from visitors providing too much information at a given time.

In addition to the ranking information described above, a bidirectional feature may also be provided, wherein visitors provide feedback on the attraction of exhibits (and/or associated themes). If provided, feedback may be accessed by organizers (e.g., museum staff) to better improve upon the visitor experience by enhancing displays and/or accommodations in the future. Real-time feedback on scored events allows application of artificial intelligence algorithms (such as learning algorithm picking up what visitor truly likes) to be applied allowing the system to be able to identify visitor undeclared interest (i.e. interests not specifically entered by visitors during activation or a profile initiation session) and dynamically updating a secondary interest profile. This will allow a closer tailoring of the themes of presentation to the visitor's true taste subconsciously.

As noted above, the relational database may be manually and/or automatically populated with ranking information and/or feedback as part of a system operating in a discovery mode. This ranking information and/or feedback may further be correlated so as to provide customized/customizable themes for ongoing or future presentations. By way of example, ranking information from a given visitor may be correlated with dynamic information on that visitor and other similar visitors. For example, the database may correlate rankings from visitors of a particular age group—e.g., teenagers, senior citizens, and children. Once correlated, themes of highly ranked exhibits can be set up for visitors/groups of visitors based on their respective dynamic information—e.g., tours for teenagers, senior citizens, and children. The system may prompt and/or suggest theme based activities to the visitor, such as exhibits the visitor may particularly be interested in. In this manner, museum visitors not only engage themselves in the activities, but also influence the themes for future visitors.

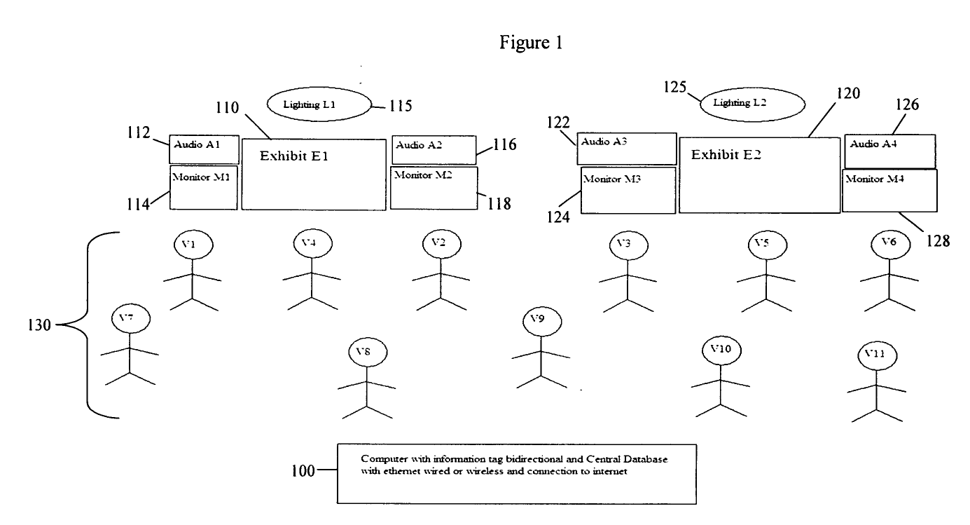

Turning now to the embodiment shown in FIG. 1, a computer 100 is provided with access to a relational database (e.g., a database remotely accessed over a wired or wireless Ethernet LAN, over an Internet WAN connection, or locally accessed). The relational database in this particular embodiment is shown as a Central Database and is centrally located so as to be accessible by other computers 100 (not shown). However, the relational database could be distributed. Preferably, the computer 100's access to the relational database allows for querying to provide theme based presentations to visitors, for querying to provide feedback information to museum staff, and for maintaining/updating the relational database as in a discovery mode or the like.

Also shown in FIG. 1 are two exhibits E1 and E2, labeled 110 and 120 respectively. The exhibits 110, 120 are preferably associated with one or more nodes. Exhibit E1 110, for example, includes associated nodes Audio A1 112, Monitor M1 114, Audio A2 116, Monitor M2 118, and Lighting L1 1115. Similarly, Exhibit E2 120 includes associated nodes Audio A3 122, Monitor M3 124, Audio A4 126, Monitor M4 128, and Lighting L2 125. The Audio nodes, Monitor nodes and the Lighting nodes preferably belong to a class of fixed router nodes that interface with visitors and/or museum staff V1 to V11, labeled as a group 130. Each visitor represents a visitor node, in that the visitor node interacts with a router node from a given exhibit 110, 120.

It should be appreciated that, because visitors are mobile, the nodes they represent may also be mobile and may move between various exhibits, such as between exhibits 110, 120. Preferably, the visitor nodes operate in “sleepy” modes while moving between router nodes or after a given period of time at a particular exhibit, wherein the visitor nodes power down (partially or wholly) to conserve battery power.

The visitor nodes may comprise a visitor that manually enters information into an input device located at one or more of the router nodes. However, more preferably the visitor nodes comprise a mobile device, such as a wired/wireless tag module or a cell phone/iphone/palm top device/PDA. Most preferably, the visitor nodes comprise a two-way, bidirectional identification tag module with a proximity locator. An exemplary device adaptable for use with system disclosed herein is described in copending application Ser. No. 11/363,103 entitled “System and Method For Creating A Proximity Map Of Living Beings And Objects,” the disclosure of which is incorporated by reference herein in its entirety. It should be appreciated that a wireless or wired tag module, such as the portable devices described in the '103 application, could be distributed and/or activated at a kiosk or other location (e.g., at museum entrance, an information desk, etc.) so as to be usable with one or more systems described herein. Similarly, wireless or wired tag module could be distributed with other techniques and pre-registered over a remote connection (e.g., using an internet website). An example of the mobile bidirectional device is the programmable Texas Instruments MSP430 Ultra Low Power Microcontroller designed with the complete development tool eZ430-RF2500. It can run on either Zigbee or SimpliciTi RI/IF wireless protocol. It can be programmed as an end node (visitor node) or a router node. The USB interface is built-in and it allows interfacing to digital photo frames, ebooks, electronic billboards (Application device). The programmed development tool when plugged into the application device USB port provides the wireless router integration into device. Additional programming on the application device may be needed to transform it into a unit capable of selecting the presentation. The microdatabase can be created either in the router eZ430-RF2500 development tool or in the application device to store the selection choices. The application device may have a microcontroller instead of a powerful computer. The device must be capable to run the different presentations.

Router nodes can preferably interface with such visitor nodes wirelessly (e.g., by RF, by IR, by WiFi, etc.) when the visitor nodes come within a known range or by wired connections (e.g., by a USB interface, a RS232 interface, a Firewire interface, etc.) when a visitor node is plugged in to the exhibit. If done wirelessly, the router node may discern whether a visitor node has come within a known range based on signal strength or triangulation. It should be appreciated that interaction between the router nodes and visitor nodes and relational database may be in accordance with a tree model (i.e., where intelligence is primarily provided on a central computer and nodes are considered dumb terminals), in accordance with a mesh model (i.e., where nodes are considered smart terminals and may offload certain capabilities from the central computer), or in accordance with other models.

In operation, once a given visitor node and router node have interfaced, the visitor node may provide information about the Exhibit (e.g., ranking information or feed), may retrieve information about the Exhibit (e.g., detailed information about what is shown), may retrieve information about similar Exhibits that fall within a particular theme (e.g., Exhibits of interest to teenagers, senior citizens, children, etc.), and/or may trigger certain activities. In addition, the visitor node may provide additional information about the visitor (e.g., age, gender, language ability, interests, identification, etc.) for correlating with information about the Exhibit, for retrieving information about the Exhibit (e.g., information in language that the visitor can understand, information in a detail corresponding with the visitor's age, etc.), for retrieving information about similar Exhibits that fall within a theme the visitor would have interest in, and/or for triggering certain activities. Information may be provided by the visitor node using various input devices as previously described, and may be conveyed to/from the visitor node via router nodes 112, 114, 115, 116, 118, 122, 124, 125, 126, 128. Information may also be conveyed to the visitor by way of a display/audio on the visitor node itself (such as iPod, if provided).

By way of example, assume visitor V1 comes within a known distance, such as 100 feet, of Exhibit E1 110 with associated nodes A1 112, M1 114, and L1 115 forming part of Exhibit E1 110 and can communicate with one another over an active network. At least one of the nodes at Exhibit E1 110 retrieves the V1 tag ID and provides this V1 tag ID to the relational database via computer 100. The relational database, in turn, identifies information that can be used in a theme based presentation for Exhibit E1 110 based on dynamic information for the visitor V1. This identified information may be identified solely based on the V1 tag ID (e.g., if a profile for the V1 tag ID exists in the system), and/or may be identified based in part on additional information. For example, the visitor V1 may manually enter dynamic information such as age, gender, language abilities, interests or theme selection on an input device and this manually entered dynamic information may be provided to the relational database along with (or in some instances in place of) the V1 tag ID.

According to at least one embodiment, the theme based presentation for Exhibit E1 110 involves certain information being audibly or visually presented to the visitor at the Exhibit E1 110. For example, the lighting L1 115 can be triggered to shine lights on a portion of the Exhibit E1 110 of particular interest to the visitor. Similarly, the Monitor M1 114 and/or Audio A1 112 can be triggered to provide information in a language format consistent with the visitor's language abilities. In addition, if the visitor has a wired/wireless tag module or a cell phone/iphone/palm top device/PDA with display or audio capabilities, the relational database may provide information to the wired/wireless tag module or a cell phone/iphone/palm top device/PDA to provide a theme based presentation thereon.

According to at least one embodiment of the present invention, the visitor can interrupt a theme based presentation. For example, a visitor may press a button to quicken the pace, query for more detail, pause, fast forward or rewind. Similarly, the visitor may press a button to notify the system that the visitor wishes to proceed to another exhibit. Consistent with a theme based presentation, the relational database may provide information at this point used to direct the visitor on a guided tour to Exhibit E2 120. For example, the relational database may provide information used to trigger direction indicators (e.g., on wall or hallway) that help the visitor navigate from Exhibit E1 110 to Exhibit E2 120. At any point during this process, the visitor may provide ranking information and/or feedback about the theme based presentations or Exhibits.

As demonstrated by the embodiments above, one or more of the features may require a communication link between nodes and/or between nodes and a relational database. According to one embodiment, the router nodes are connected to the computer 100 by way of a predefined reporting network. Using a predefined reporting network topology may shorten network seek, identification, authentication, and link processes and times—thereby dramatically reducing consumption of available network bandwidth. The network topology may connect all or a subset of the router nodes to computer 100 (with access to a relational database) by way of a high bandwidth backbone network, such as Ethernet, ATM, Frame Relay, 802.11 b,g,n, and Zigbee, and SimpliciTI.

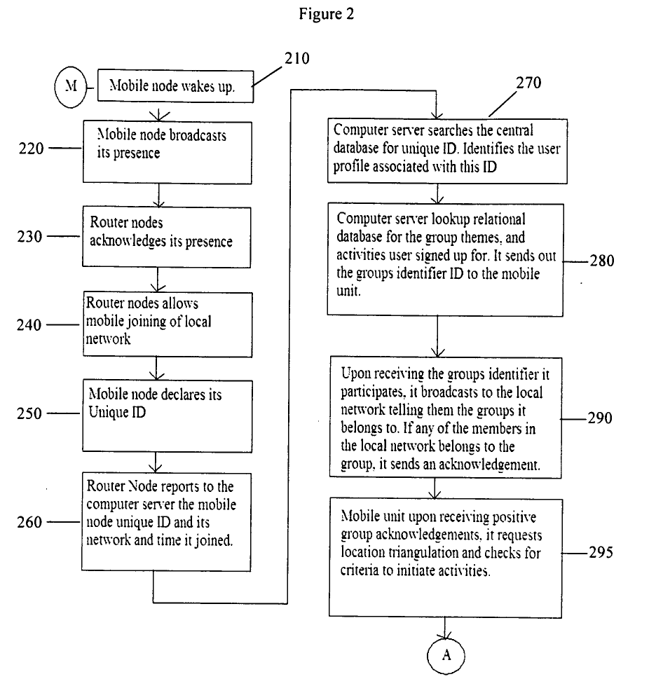

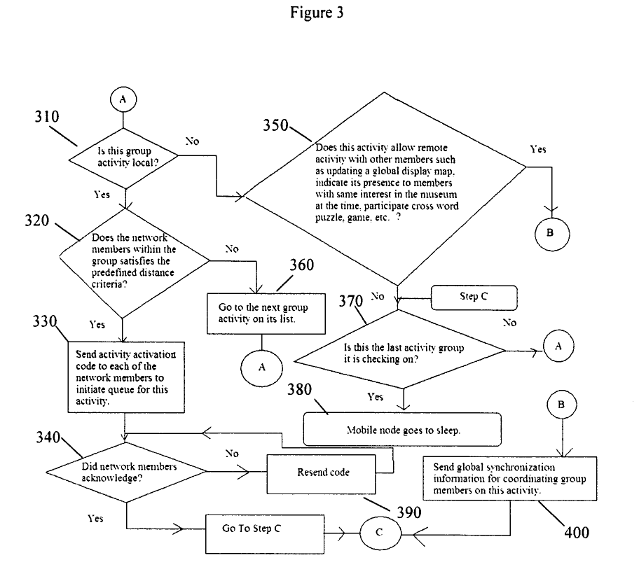

A method of providing a theme based presentation according to another embodiment of the present invention is shown in FIGS. 2 & 3. When inactive, the mobile node is preferably operated in a sleep mode to conserve battery life (see step 380, described below). Starting with step 210, the mobile node powers up when a mobile node comes within range of a router node, or in response to some other trigger (e.g., a motion sensor such as mercury switch, micro-accelerometer or from a periodic timer in its embedded microcontroller). The mobile node may comprise, for example, a portable device as described in the '103 application. The router node may comprise, for example, a component of an exhibit at a public or private facility as shown in the embodiment of FIG. 1.

In step 220 the mobile node broadcasts its presence to a router node, which acknowledges the mobile node's presence in step 230. This exchange may take place wirelessly (e.g., over a WiFi connection, an IR connection, an RF connection, etc.) or by a wired connection (e.g., over a USB interface, RS232 interface). Preferably, the router node allows the mobile node to join a local network in step 240. As an example, the local network may comprise a local Ethernet or WiFi network and may include multiple components of a given exhibit. The mobile node's admission to the local network may be conditional for security purposes, such that the mobile node's access to the network is restricted to particular functions.

In step 250, the mobile node declares its unique ID. Step 250 may comprise, for example, the reading of embedded ID information on the mobile node. Alternatively, a visitor with the mobile node may manually enter ID information with an input device. The unique ID declaration may be automatically provided by the mobile node, or it may be provided in response to a request from another device, such as a router node.

In step 260, the router node reports to a computer server the mobile node unique ID. As part of step 260, the router node may also report to the computer server information about the local network, the time the mobile node joined the local network, or other useful information. The router node's reporting to a computer server may comprise transmitting data via a wired or wireless network connection, such as over a LAN or WAN.

In step 270, the computer server searches a central database (e.g., a centrally stored relational database) corresponding to the mobile node unique ID. For example, step 270 may comprise identifying a profile associated with the mobile node unique ID. If such a profile does not exist, the central database may be manipulated so as to create a new profile associated with the mobile node unique ID. Preferably, the profile was created prior to step 210 as part of a registration or activation step (e.g., at an information desk or kiosk).

In step 290, the computer server identifies information that can be used to provide a customized/customizable theme based presentation corresponding to the mobile node unique ID and/or other information provided by the user thereof. For example, step 290 may comprise identifying a group theme or activity the user previously signed up for. Examples include all activities of interest to teenagers, all activities that involve military aircraft, art related activates excluding sculptures, all activities related to the Bronze Age, only those activities related to Bronze Age jewelry, only those activates related to Bronze Age tools, etc. Flexibility in theme based creation and correlation with dynamic information can be particularly advantageous.

By way of non-limiting example, if a visitor wants to understand the relationship between tools used to make Bronze Age jewelries and its time development, then the router nodes could narrate and direct the visitor's mobile node accordingly, instead of according to fixed rigid floor plan of all Bronze Age exhibits. Furthermore, the visitor should be able to provide ranking information and/or feedback that are used to improve upon the themes and/or the router nodes. This dynamically updating method is particularly advantageous in museums (and the like), where groups may need to be diverted to restrooms or other ‘distractions’ that may not be close by. In situations like these, it may be advisable to be able to dynamically recalculate a visitor's path through a museum, perhaps from a new, closer starting point. Dynamically recalculating paths can prove useful, furthermore, if certain groups need to be separated. For example, if VIPs or large tour groups need to be avoided, visitors can be rerouted around their paths to minimize the number of interactions.

To facilitate improved theme based presentation, step 290 may include an exchange between the computer server and the mobile node, whereby the computer server queries the mobile node for additional information that can be used to identify a group theme or activity the user may be interested in. By way of example, if no profile is identified as part of step 270, the user may answer one or more questions in step 280 that are used to populate the user's profile and to identify a group theme or activity the user may be interested in. To illustrate, the computer server may query the mobile node in step 280 for age, gender and language ability information or may provide a list of selectable theme based presentations available for that local network.

Step 280 may also include the computer server transmitting a group identifier (or other information used to provide a theme based presentation) to the mobile node for subsequent use in steps 290+. Alternatively, the computer server may transmit the group identifier (or other information used to provide a theme based presentation) directly to one or more of the router nodes. In either case, the group identifier information can be used to provide the theme based presentation in steps 290+.

In step 290, the mobile node preferably receives the group identifier from the computer server and broadcasts this group identifier on the local network. This broadcast, in turn, may trigger members of the local network to send an acknowledgement to the mobile node and/or to activate theme based presentations. It should be appreciated that members of the local network may include router nodes and/or other mobile nodes corresponding to other users or to staff.

In step 295, the mobile node may identify its location (e.g., by location triangulation techniques) and/or criteria that is used to initiate theme based presentation activities. For example, the mobile node (or alternatively the router nodes) may in step 310 determine whether or not the group identifier corresponds to a local activity. As an example, if the mobile node has joined a local network for an aircraft exhibit, the mobile node may determine whether or not the aircraft exhibit has a theme based presentation for members of that group identifier.

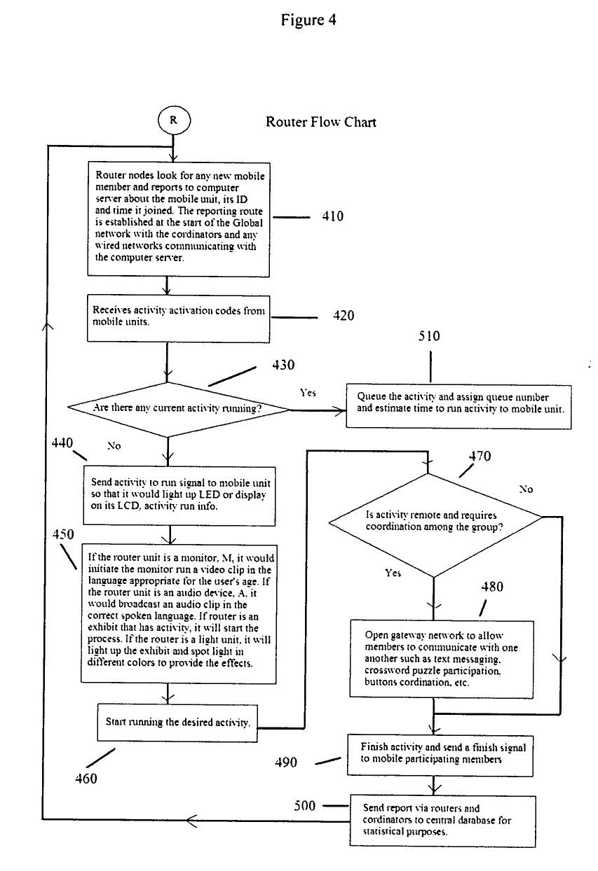

If the group identifier does not correspond to a local activity, the mobile node may in step 350 determine whether or not there is a corresponding remote activity available. For example, other mobile nodes within sufficiently close proximity to the mobile node (e.g., that are currently joined with the local network) may interface with one another so as to participate in a game (e.g., a crossword puzzle). Similarly, the mobile node may query other mobile nodes as to whether there is an aspect of the local activity that the user may still be interested in. For some embodiments, an activity may involve remote actions with other global members such as updating a global map, indicating presence to members with the same interest in the museum at the time, or participating in crossword puzzle, game, etc. For these embodiments, the functionality follows step B to step 400 described in reference to FIG. 4 below. After such a process has completed, the functionality may return to step C as shown.

If there are no remote activities, the mobile node in step 370 determines whether it is the last activity group it is checking on. By way of example, step 370 may correspond to verifying whether the mobile node has experienced all of the exhibits corresponding to that user's group ID in an entire facility. Alternatively, step 370 may correspond to verifying whether the mobile node has experienced all of the exhibits corresponding to that user's group ID in a portion of a facility—e.g., in a wing covered by the joined local network. If other activity groups exist, operation returns to step 310. If no other activity groups exist, the mobile node goes to sleep in step 380 until in comes into presence within range of a router node on a different local network.

Turning back to step 310, if the group identifier does correspond to a local activity, the mobile node (or router nodes) determines in step 320 whether a known distance criteria is satisfied. As an example, the mobile node may determine whether it is sufficiently close to a particular part of an exhibit (e.g., to Audio A1 112 or Monitor M1 114 from the embodiment shown in FIG. 1). If not, the mobile node (or router nodes) proceeds in step 360 to the next group activity on the list, such as a different part of the exhibit.

If, however, in step 320 the known distance criteria is satisfied, the mobile node in step 330 preferably sends an activity activation code to one or more of the router nodes. For example, the activity activation code may be sent to Lighting L1 115, Audio A1 112, and/or Monitor M1 114 for a portion of Exhibit E1 110 as shown in the embodiment of FIG. 1. Preferably step 330 results in an acknowledgment in step 340 and the theme based presentation begins. Once concluded, the mobile node in step 370 determines whether it is the last activity group it is checking on. If acknowledgment is not received in step 340, however, the mobile node may cause the activity code to be resent in step 390.

Router nodes are generally attached to fixed locations forming the critical network communication backbone. This allows for a more permanent network architecture to be formed and continuous power supply connections to these units are an option. Therefore, routers always have a reporting network, allowing constant communication with the coordinators and computer servers. Routers also communicate directly with mobile devices, and therefore keep a list of which mobile units belong to its family and update them periodically.

Embedded sensors, active devices, displays, embedded processors can also be attached to these router nodes directly. It is this feature that enables custom lightings, custom LCD messages, video etc interface with the exhibit visitor.

FIG. 4 depicts an exemplary Router Flowchart according to an embodiment of the present invention, the flowchart including details on how a router node can interact with both mobile units and coordinator/computer server. During the power on routine, the router node first establishes its Global network formation with the coordinator, computer server and local mobile units. The router node subsequently looks for any new mobile member to join its network in step 410. It reports any newly joined mobile unit ID and the time it joined to the computer server.

After updating the network of mobile nodes, the router node prepares itself for receiving activation codes from the mobile units 420. These activation codes are originated from mobile units 330 telling the router that it has to initiate a specific activity, such as to shine a spot light or run a video clip, etc. Before starting this activity, the router first check its activity queue status and determine whether a current activity is ongoing 430. If it is busy running another activity, it has to be queued and informed back the mobile unit that sent the activity request in step 510. Otherwise, it will honor the activity request and play the video. In addition, it will send an activity acknowledgement to run signal back to the mobile unit. This signal can be an LED or sending text to the LCD on the mobile unit as in step 440.

If the activity is playing a video clip, the router would instruct the monitor to run this video clip in the language appropriate for the usage's age. On the other hand if the router activity is an audio clip, it will ensure broadcast it in the correct spoken language. If the activity is a spot light, it will program the display with the color scheme providing different colors to enhance the visual effects. All these preparations happen in step 450. In step 460, the system will run the selected desired activity.

In Step 470, the system determines whether the activity is a remote event. A remote event requires coordination of activities among other group members. This information comes from the mobile unit in Step 350 and labeled B. If the event is determined remote, at step 480 the system it will open the gateway through its upper hierarchy network to allow other global members to communicate with one another. This activity could be text messaging allow other members to view the same message, or a crossword puzzle event that allows other participating mobile members to enter their words. It can even be a game allowing remote buttons to be activated.**

In step 490, a conclusion of activity signal is sent to all participating mobile members. This signal will close the open gateway.

Finally in step 500, a report is sent via the router to coordinators and computer server and enters as a record on the central database for statistical purposes. This concludes the cycle and return back to step 410, waiting for any new mobile units to join and add any new activities.

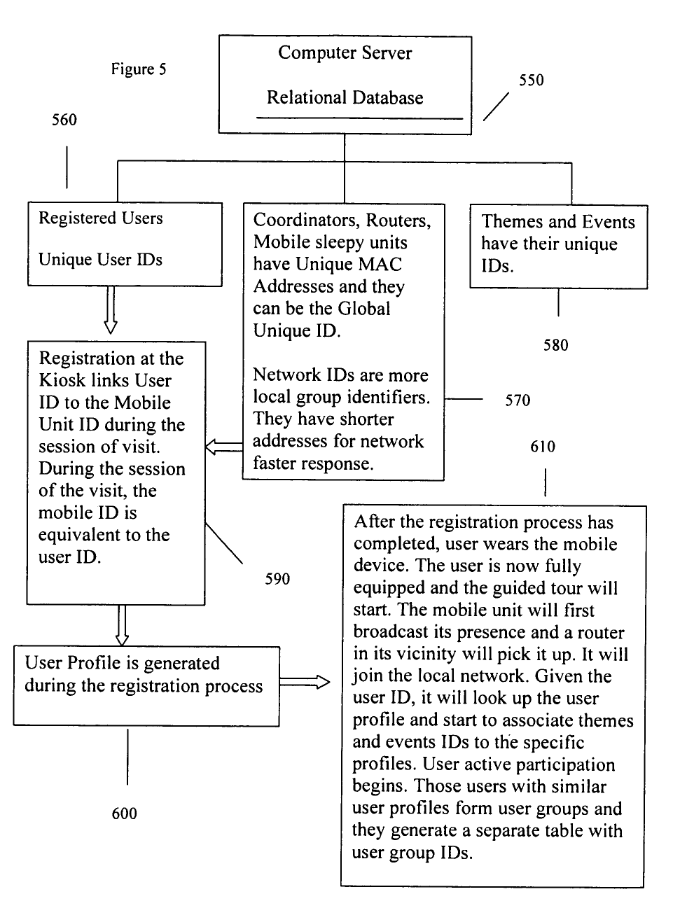

FIG. 5 shows the summary from a relational database 550 according to an embodiment of the present invention. By way of example, the relational database could be residing in a computer server and used as part of a Kiosk registration process. The relational database in the computer server stores three kinds of tables of IDs. The first ID table is the Registered User IDs, 560, and they are all unique. The second ID table is the Network IDs, 570, table which stores two types of addresses, namely the Global unique ID which can be the MAC address and the local network ID address. The local address is shorter and it is also dynamic and it allows fast communication among the routers and the mobile units. Every unit is always traceable to its Global Unique ID and this tracking is performed under the network operation system. The third ID table, 580, is the Themes IDs and Events IDs and it contains entire list of different themes and events. Given a specific user profile, certain themes are linked to it. This mapping of user profile to themes and events is a programmable and therefore dynamic.

During the user registration, new registrations will be given new unique user ID in step 590. However, returning visitors will retrieve their previous ID at the registration Kiosk. User profiles are collected during the registration process for new users and retrieved from returning users as indicated in step 600. After the user profile is generated, a mobile unit is dispensed for user to wear in step 610. This mobile unit ID will then be linked to the unique user ID during the entire session and it would be a recorded event in the relational database. At this point the user is ready to begin its tour. This will bring it back to flowchart in FIG. 2.

There may be many users with similar user profiles, such that it may be useful to generate user group profiles IDs in a separate table. For example, if the user group likes to do crossword puzzles, those within the group can team up to work on the puzzles. This coordinated effort can be performed at various locations all at once. They all work on various clues from different exhibits to arrive at one solution. This is the power of such a disperse network architecture.

In should be appreciated that features of certain embodiments may include the following:
1) The ability to understand individual personal characteristics by collecting user profile either by direct user input from Kiosk or indirectly from user feedback collected information. (At times enhanced by artificial intelligence). The use of the user profiles allows customized themes to be presented to user and active user participation throughout the visit is embedded in the process giving user a fully meaningful, enjoyable, and entertaining experience.
2) Use of dynamic network architecture based on coordinators, routers and mobile units to adapt to the environment. Visitors' interests and their visiting times are fully unpredictable. An inherent dynamic network architecture can address this requirement. New network tree, new mesh formation allows adaptation to visitors on-the-fly.
3) The system has a proximity feature that determines dynamically who are local members. This enables all (or a subset) of local participants to enjoy the local group activities. The size of this group is dynamic too. The proximity criteria is programmable according to each application.
4) Mobile units are carried by visitors. They have to be small and battery operated. Efficient, low energy consumption criteria is inherent in this design. The mobile unit goes to sleep and respond when it has an event or near a router.
5) Architectural design accommodates both low and high bandwidth activity demands such as lighting, text, audio and video clips. It also allows devices such as iPods, iPhones, cell phones, PDAs, etc. to be interfaced.
6) Global collective activities are inherently configured on demand in the network allowing coordinated activities such as messaging to a group with similar interest, crossword puzzle, game event, etc.

The foregoing description of various embodiments of the present invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

What is claimed is:

1. A theme based presentation system, comprising:
a processor with access to a relational database, the relational database including a plurality of group identifiers corresponding to a plurality of theme based activities;
a plurality of router nodes, each router node being adapted and configured to run at least one theme based activity; and
at least one mobile node, each mobile node having a unique ID;
wherein the plurality of router nodes are triggered to run the at least one theme based activity based on a group identifier from the plurality of group identifiers corresponding to the unique ID of the at least one mobile node.

2. The theme based presentation system of claim 1, wherein the processor is a microcontroller, a CPU or a server with multiple CPUs.

3. The theme based presentation system of claim 1, wherein the unique ID comprises a globally unique ID.

4. The theme based presentation system of claim 1, wherein the unique ID comprises a locally unique ID.

5. The theme based presentation system of claim 1, wherein the at least one mobile node includes a transceiver adapted and configured to transmit the unique ID to at least one router node.

6. The theme based presentation system of claim 1, further comprising a local network including a group of router nodes corresponding to an exhibit.

7. The theme based presentation system of claim 6, wherein the at least one mobile node includes a transceiver adapted and configured to join the local network when within a known distance of at least one of the router nodes in the group of router nodes.

8. The theme based presentation system of claim 1, wherein each router node includes at least one of lighting, a video display, an audio display, or a direction sign.

9. The theme based presentation system of claim 1, wherein the at least one mobile node comprises one of an MP3 player, a cellular phone, and a tag module.

10. A method of providing a theme based presentation, comprising:
detecting the presence of a mobile node within a range of a router node;
querying a relational database with a unique ID of the mobile node for a group identifier corresponding to the theme based presentation; and
triggering at least one activity based on the group identifier.

11. The method of claim 10, wherein the group identifier excludes certain activities based on a user profile corresponding to the unique ID.

12. The method of claim 11, further comprising populating the relational database.

13. The method of claim 12, wherein populating the relational database comprises receiving ranking information from the mobile node.

14. The method of claim 10, wherein querying a relational database comprises transmitting data over at least one of a wireless and a wired network.

15. The method of claim 10, further comprising activating the mobile node prior to detecting the presence of the mobile node within the range of the router node.

16. The method of claim 10, further comprising joining a local network including the router node after detecting the presence of the mobile node within the range of the router node.

17. The method of claim 10, wherein triggering at least one activity based on the group identifier comprises directing the mobile node to router nodes capable of running activities of interest for the group identifier.

18. The method of claim 10, wherein triggering a least one activity based on the group identifier comprises running a game on the mobile node.

19. The method of claim 10, wherein the relational database is distributed into local microdatabases, each microdatabase corresponding to one of a local network and a grouping of unique IDs.

20. The method of claim 10,
wherein querying a relational database with the unique ID of the mobile node for the group identifier comprises providing both a first and a second group identifier corresponding to distinct theme based presentations, and
wherein triggering at least one activity based on the group identifier comprises triggering a plurality of activities corresponding to the first and second group identifiers.

21. The method of claim 20, wherein triggering the plurality of activities corresponding to the first and second group identifiers comprises simultaneously triggering the plurality of activities corresponding to the first and second group identifiers.

22. The method of claim 10, further comprising providing bidirectional communication between the mobile node and the relational database through nodes within a given network tree, at least one of the nodes including a broadband link to a computer maintaining the relational database.

23. The method of claim 22, further comprising maintaining a current network tree report within the relational database.
